(19) United States
(12) Patent Application Publication
(10) Pub. No.: US 2014/0229415 A1
(43) Pub. Date: Aug. 14, 2014

(54) COMPUTING SYSTEM WITH MULTI-CLASS CLASSIFIERS MECHANISM AND METHOD OF OPERATION THEREOF

(71) Applicant: Samsung Electronics Co., Ltd., Gyeonggi-Do (KR)

(72) Inventors: Justin Martineau, San Jose, CA (US); Doreen Cheng, San Jose, CA (US)

(73) Assignee: Samsung Electronics Co., Ltd., Gyeonggi-Do (KR)

(21) Appl. No.: 14/158,525

(22) Filed: Jan. 17, 2014

Related U.S. Application Data
(60) Provisional application No. 61/764,919, filed on Feb. 14, 2013.

(51) Int. Cl. G06N 5/02

(52) U.S. Cl. CPC G06N 5/02
USPC 706/46

(57) ABSTRACT

A computing system includes: a first communication unit configured to receive a feature within a data object; and a control unit, coupled to the first communication unit, configured to: calculate a feature weight of the feature for each classes, generate a model vector for each of the classes based on the feature weight, calculate a spread feature score based on the model vector, a spread parameter, or a combination thereof for changing a spread distance amongst a plurality of the feature weight.

### CROSS-REFERENCE TO RELATED APPLICATION

This application claims the benefit of U.S. Provisional Patent Application Ser. No. 61/764,919 filed Feb. 14, 2013, and the subject matter thereof is incorporated herein by reference thereto.

The present application contains subject matter related to a U.S. patent application Ser. No. 13/890,541 filed May 9, 2013, which claims the benefit of U.S. Provisional Patent Application Ser. No. 61/645,550 filed May 10, 2012, 61/676,279 filed Jul. 26, 2012, and 61/791,088 filed Mar. 15, 2013, and the subject matter thereof is hereby incorporated herein by reference thereto.

### TECHNICAL FIELD

An embodiment of the present invention relates generally to a computing system, and more particularly to a system for multi-class classifiers.

### BACKGROUND

Modern consumer and industrial electronics, such as computing systems, televisions, projectors, cellular phones, portable digital assistants, and combination devices, are providing increasing levels of functionality to support modern life. In addition to the explosion of functionality and proliferation of these devices into the everyday life, there is also an explosion of data and information being created, transported, consumed, and stored.

The explosion of data and information comes in different types, e.g. text, sounds, images, as well as for different emotion datasets/applications, e.g. social networks, electronic mail, web searches, and different formats, e.g. structure, unstructured, or semi-structured. Research and development for handling this dynamic mass of data and information in existing technologies can take a myriad of different directions.

Thus, a need still remains for a computing system with multi-class classifiers mechanism for effectively addressing the mass of data and information across various emotion datasets. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides a computing system, including: a first communication unit configured to receive a feature within a data object; and a control unit, coupled to the first communication unit, configured to: calculate a feature weight of the feature for each classes, generate a model vector for each of the classes based on the feature weight, and calculate a spread feature score based on the model vector, a spread parameter, or a combination thereof for changing a spread distance amongst a plurality of the feature weight.

An embodiment of the present invention provides a method of operation of a computing system including: calculating a feature weight of the feature for each classes with a control unit; generating a model vector for each of the classes based on the feature weight; and calculating a spread feature score based on the model vector, a spread parameter, or a combination thereof for changing a spread distance amongst a plurality of the feature weight.

An embodiment of the present invention provides a non-transitory computer readable medium including: calculating a feature weight of the feature for each classes; generating a model vector for each of the classes based on the feature weight; and calculating a spread feature score based on the model vector, a spread parameter, or a combination thereof for changing a spread distance amongst a plurality of the feature weight.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with multi-class classifiers mechanism in an embodiment of the present invention.

FIG. 2 is an exemplary block diagram of the computing system.

FIG. 3 is a control flow of the computing system.

FIG. 4 is a graphical representation of the feature weight and the spread feature score.

FIG. 5 is a change in the spread distance based on the bar graph illustrated in FIG. 4.

FIG. 6 is an architecture view of an exemplary application for a model synthesis with the computing system.

### DETAILED DESCRIPTION

An embodiment of the present invention provides a method and system configured to calculate a feature weight for a feature extracted from a data object. The extraction is for determining an item orientation for whether the data object has a positive orientation or a negative orientation towards a class. To improve the accuracy of determining the item orientation and to improve the system for providing recommendation, a spread feature score is calculated to change a spread distance amongst a plurality of the feature weight to magnify the distinctiveness of each instances of the feature weight in a model vector. This changes the relative impact of the model vector for the recommendation. The change to the relative impact on the recommendation is determined by the desired spread or squish of the spread distance.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

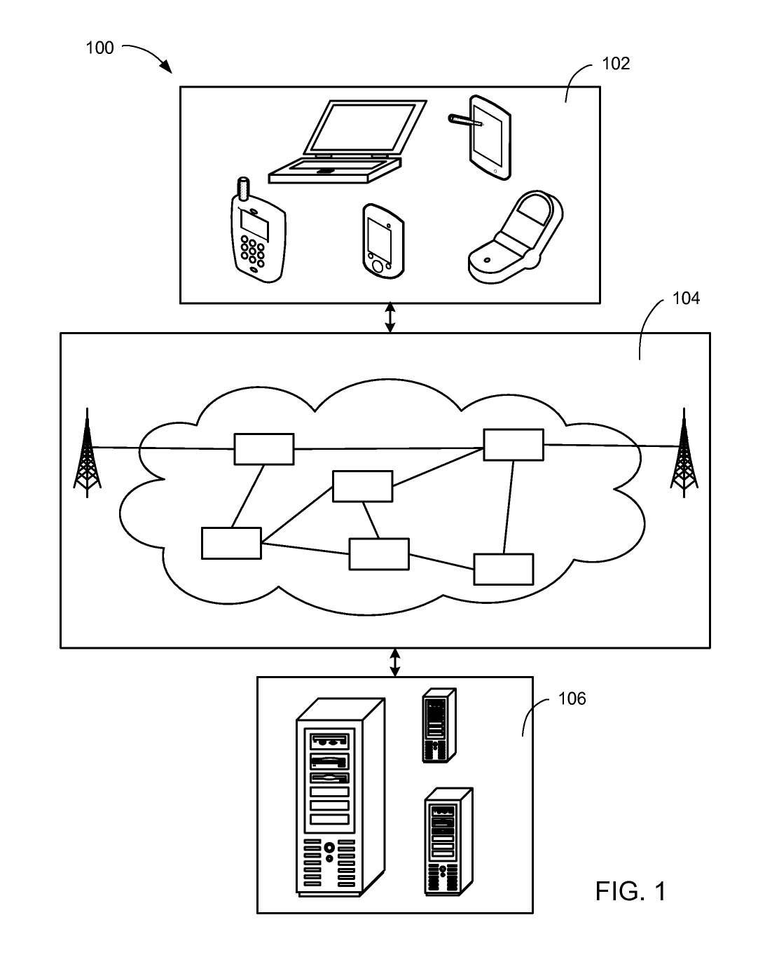

Referring now to FIG. 1, therein is shown a computing system 100 with multi-class classifiers mechanism in an embodiment of the present invention. The computing system 100 includes a first device 102, such as a client or a server, connected to a second device 106, such as a client or server. The first device 102 can communicate with the second device 106 with a communication path 104, such as a wireless or wired network.

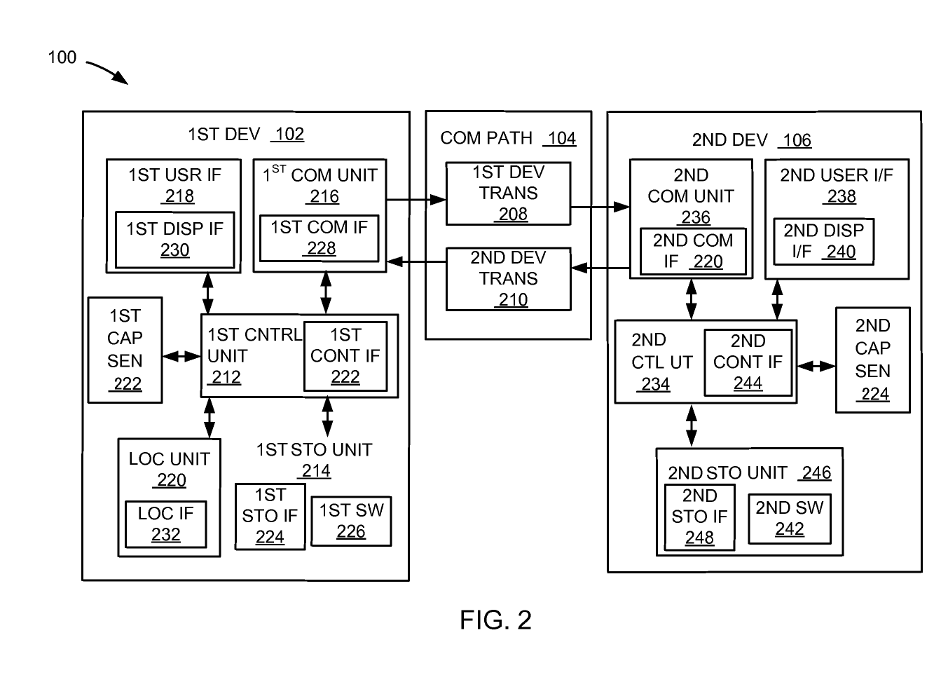

Users of the first device 102, the second device 106, or a combination thereof can communicate with each other or access or create information including text, images, symbols, location information, and audio, as examples. The users can be individuals or enterprise companies. The information can be created directly from a user or operations performed on these information to create more or different information. The communication involving can take more different forms, as described more in FIG. 2.

In the connected world, information creation, transmission, and storage are pervasive as well as the desire to consume all these information by the users. However, the shear mass of information makes it impossible to effectively and efficiency consume or deliver the right information and the right time.

Returning to the description of the computing system 100, the first device 102 can be of any of a variety of devices, such as a smartphone, a cellular phone, personal digital assistant, a tablet computer, a notebook computer, or other multi-functional display or entertainment device. The first device 102 can couple, either directly or indirectly, to the communication path 104 to communicate with the second device 106 or can be a stand-alone device.

For illustrative purposes, the computing system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, text or a combination thereof.

The second device 106 can be any of a variety of centralized or decentralized computing devices, or transmission devices. For example, the second device 106 can be a laptop computer, a desktop computer, a video game console, grid-computing resources, a virtualized computer resource, cloud computing resource, routers, switches, peer-to-peer distributed computing devices, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

The communication path 104 can span and represent a variety of network types and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

Referring now to FIG. 2, therein is shown an exemplary block diagram of the computing system 100. The computing system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the computing system 100.

The first control unit 212 can be implemented in a number of different manners. For example, the first control unit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is physically separate from the first device 102.

The first control interface 222 can receive information from the other functional units or from external sources, or can transmit information to the other functional units or to external destinations. The external sources and the external destinations refer to sources and destinations physically separate from the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

A first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between and other functional units in the first device 102. The first storage interface 224 can also be used for communication that is physically separate from the first device 102.

The first storage interface 224 can receive information from the other functional units or from external sources, or can transmit information to the other functional units or to external destinations. The external sources and the external destinations refer to sources and destinations physically separate from the first device 102.

The first storage interface 224 can include different implementations depending on which functional units or external units are being interfaced with the first storage unit 214. The first storage interface 224 can be implemented with technologies and techniques similar to the implementation of the first control interface 222.

A first communication unit 216 can enable external communication to and from the first device 102. For example, the first communication unit 216 can permit the first device 102 to communicate with the second device 106 of FIG. 1, an attachment, such as a peripheral device or a computer desktop, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include a display, a projector, a video screen, a speaker, or any combination thereof.

The first control unit 212 can operate the first user interface 218 to display information generated by the computing system 100. The first control unit 212 can also execute the first software 226 for the other functions of the computing system 100. The first control unit 212 can further execute the first software 226 for interaction with the communication path 104 via the first communication unit 216.

The second device 106 can be optimized for implementing the present invention in a multiple device embodiment with the first device 102. The second device 106 can provide the additional or higher performance processing power compared to the first device 102. The second device 106 can include a second control unit 234, a second communication unit 236, and a second user interface 238.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the computing system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the computing system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is physically separate from the second device 106.

The second controller interface 244 can receive information from the other functional units or from external sources, or can transmit information to the other functional units or to external destinations. The external sources and the external destinations refer to sources and destinations physically separate from the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the computing system 100 is shown with the second storage unit 246 as a single hierarchy storage system, although it is understood that the computing system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between other functional units in the second device 106. The second storage interface 248 can also be used for communication that is physically separate from the second device 106.

The second storage interface 248 can receive information from the other functional units or from external sources, or can transmit information to the other functional units or to external destinations. The external sources and the external destinations refer to sources and destinations physically separate from the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244. The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The computing system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

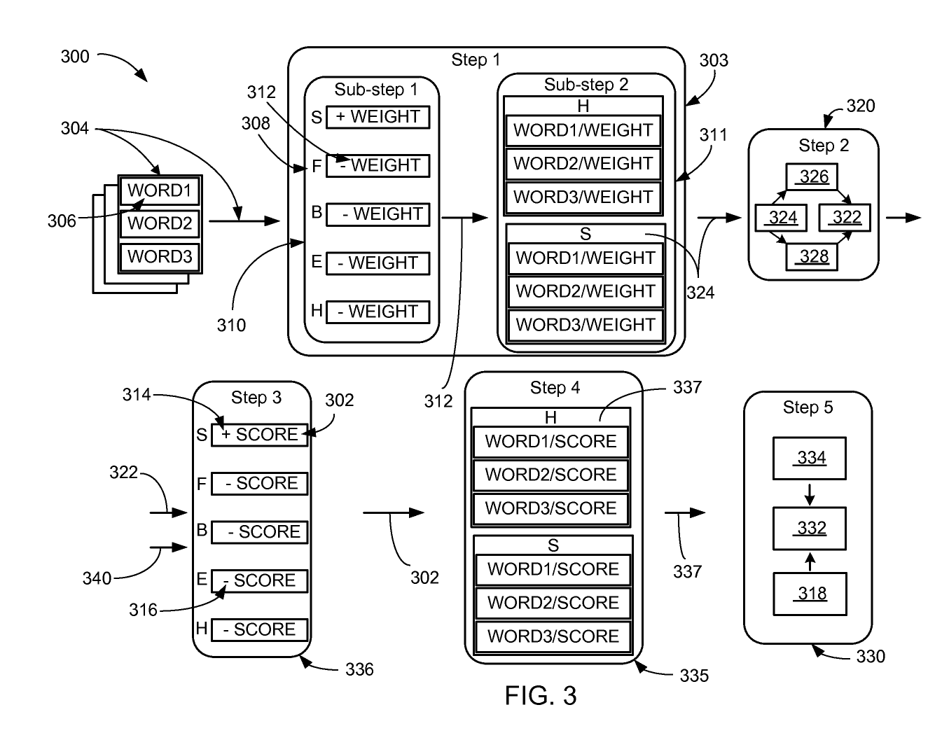

Referring now to FIG. 3, therein is shown a control flow 300 of the computing system 100 of FIG. 1. For clarity and brevity, the discussion of the embodiment of the present invention will focus on the first device 102 of FIG. 1 delivering the result generated by the computing system 100. However, the second device 106 of FIG. 1 and the first device 102 can be discussed interchangeably.

FIG. 3 depicts, as an example, a calculation of a spread feature score 302 to determine whether a data object 304 having a feature 306 is oriented towards a particular instance of a class 308. Details regarding the spread feature score 302 will be discussed below.

The data object 304 is a digitized data. For example, the data object 304 can represent a document, a social network site (SNS) feed, or a combination thereof. For a specific example, the SNS feed can represent Twitter™ feed, Facebook™ feed, LinkedIn™ feed, or a combination thereof. The feature 306 is an attribute about an item being analyzed. The item can represent the data object 304. For example, the feature 306 can represent a word, a phrase, a text, an n-gram of words, or a bag of characters for the document or item being analyzed.

The computing system 100 can include a weight module 303 depicted as “Step 1” in FIG. 3. The vector module 303 generates a model vector 324. For example, the vector module 303 can generate the model vector 324 based on a feature weight 312.

The vector module 303 can include a training module 310 depicted as “Sub-step 1” in FIG. 3. The training module 310 calculates the feature weight 312 for the class 308 of the feature 306. The feature weight 312 is a score to indicate an orientation of the feature 306 towards the class 308. The class 308 is a category to classify the feature 306. For example, the class 308 can represent a classification of an emotion, such as “funny,” “happy,” “sad,” “exciting,” “boring,” “anger,” “fear,” “serious,” or a combination thereof. For another example, the class 308 can represent a person type, place type, political affiliation type, or a combination thereof.

The training module 310 can calculate the feature weight 312 in a number of ways. For example, the training module 310 can calculate the feature weight 312 using a machine learning algorithm. For a specific example, the machine learning algorithm can represent a binary-class learning algorithm. As an example, the training module 310 can calculate the feature weight 312 with a delta inverse document frequency (IDF). Delta IDF can be replaced with other machine learning algorithm. Furthermore, training a set of multiple binary-class classifiers using binary class classification algorithm can be “One vs. One,” “One vs. All,” or a combination thereof.

The training module 310 can calculate the feature weight 312 by training the Delta IDF model for the feature 306. More specifically, the training module 310 can calculate the feature weight 312 with Equation 1 below.

$${V}_{t} = {log}_{2} ( \frac{( \vert N \vert + 1 ) ( \vert {P}_{t} \vert + 1 )}{( \vert {N}_{t} \vert + 1 ) ( \vert P \vert + 1 )} ) \qquad Equation 1$$

“|Pₜ|” can represent a count for training instances of the data object 304 with a positive orientation 314 having the feature 306 “t.” “|P|” can represent a count for training instances of the data object 304 with the positive orientation 314. The positive orientation 314 is an indication that the feature 306 is oriented toward the class 308 of particular representation.

“|Nₜ|” can represent a count for training instance of the data object 304 with a negative orientation 316 having the feature 306 “t.” “|N|” can represent a count training instances of the data object 304 with the negative orientation 316. The negative orientation 316 is an indication that the feature 306 is oriented away from the class 308 of a particular representation.

“Vₜ” can represent the feature weight 312. The feature weight 312 above a bias threshold 318 can represent the positive orientation 314. The feature weight 312 below the bias threshold 318 can represent the negative orientation 316. The bias threshold 318 is a minimum limit to determine the positive orientation 314 or the negative orientation 316 of the data object 304. The bias threshold 318 can be set to zero or dynamically adjusted. Details regarding the bias threshold 318, the positive orientation 314, the negative orientation 316, or a combination thereof will be discussed below.

For further example, the training module 310 can calculate the feature weight 312 for the feature 306 for each representations of the class 308. More specifically, the training module 310 can calculate the feature weight 312 for when the feature 306 belongs to the class 308 representing “happy.” For another example, the training module 310 can calculate the feature weight 312 for when the feature 306 belongs to the class 308 representing “sad.” The training module 310 can receive a plurality of the data object 304 as an input to calculate the feature weight 312 for each instances of the feature 306. The training module 310 can send the feature weight 312 to a model module 311.

The vector module 303 can include the model module 311, which can couple to the training module 310. The model module 311 can be depicted as “Sub-step 2 in FIG. 3. The model module 311 generates the model vector 324, which is a pair valued model having the feature 306 and the feature weight 312 of the feature 306 for the class 308 of a particular representation. For example, the model module 311 can generate the model vector 324 for each representations of the class 308 based on the feature weight 312.

The model module 311 can generate the model vector 324 in a number of ways. For example, the model module 311 can generate the model vector 324 having a paired value representing the feature 306 and the feature weight 312 of the feature 306 for the class 308. As an example, the class 308 can represent “sad.” The feature 306 can represent “so disheartening.” The feature weight 312 can represent “positive 0.5.” The model module 311 can generate the model vector 324 having the paired value of “so disheartening” and “positive 0.5” for the class 308 representing “sad.”

For further example, the model module 311 can generate the model vector 324 for each representations of the class 308 for the same instance of the feature 306. The model module 311 can send the model vector 324 to a procedure module 320.

The computing system 100 can include the procedure module 320, which can couple to the model module 311. The procedure module 320 can be depicted as “Step 2” in FIG. 3. The procedure module 320 calculates a bias balanced vector 322. The bias balanced vector 322 is the feature weight 312 without the priori class bias.

For example, the procedure module 320 can calculate the bias balanced vector 322 based on the feature weight 312. More specifically, the procedure module 320 can calculate the bias balanced vector 322 to avoid building the model vector 324 having a biased classifier. The calculation of the bias balanced vector 322 can represent an optional step for the present invention.

The procedure module 320 can calculate the bias balanced vector 322 following a bias balancing procedure. For example, the bias balancing procedure can include the following steps. First, the procedure module 320 can generate a positive vector 326 by making a copy of the feature weight 312. A negative vector 328 can represent an original instance of the feature weight 312. Second, for every instance of the feature 306 in the positive vector 326, if the feature weight 312 of the feature 306 is less than zero, the procedure module 320 can set the feature weight 312 for that instance of the feature 306 to be zero.

Third, for every instance of the feature 306 in the negative vector 328, if the feature weight 312 of the feature 306 is greater than zero, the procedure module 320 can set the feature weight 312 for that instance of the feature 306 to be zero. Fourth, the procedure module 320 can normalize the positive vector 326 with L² norm or Euclidean norm. Fifth, the procedure module 320 can normalize the negative vector 328 with L² norm or Euclidean norm. And sixth, the procedure module 320 can calculate the bias balanced vector 322 by adding the positive vector 326 and the negative vector 328. The procedure module 320 can send the bias balanced vector 322 to a spread module 336.

The computing system 100 can include the spread module 336, which can couple to the procedure module 320. The spread module 336 can be depicted as “Step 3” in FIG. 3. The spread module 336 calculates the spread feature score 302. For example, the spread module 336 can calculate the spread feature score 302 based on comparing the feature weight 312 of the feature 306 for the class 308 to another instance of the feature weight 312 for the same instance of the feature 306 for the class 308 that is different. For another example, the spread module 336 can calculate the spread feature score 302 based on comparing the bias balanced vector 322 of the class 308 to the bias balanced vector 322 of the class 308 that is different.

The spread feature score 302 is a result of a comparison of a plurality of the feature weight 312, a spread parameter 340, or a combination thereof factored in. The spread parameter 340 is a degree of how much to spread between one instance of the feature weight 312 and another instance of the feature weight 312.

For example, the spread module 336 can spread a plurality of the feature weight 312 from each representations of the class 308 for the same instance of the feature 306 non-linearly. And the spread module 336 can spread the plurality of the feature weight 312 in proportion to the amount of spread specified in the spread parameter 340. The spread module 336 can calculate the spread feature score 302 using Equation 2 below.

$$Spread ( t , S ) = t {\sum }_{e = 1}^{x} {\vert t - {X}_{e} \vert}^{S} \qquad Equation 2$$

“t” can represent the feature weight 312 of the feature 306 for the class 308. “S” can represent the spread parameter 340. “X” can represent the feature weight 312 of the same instance of the feature 306 for the class 308 that is another. “x” can represent the number of elements of “X.” “Spread(t, S)” can represent the spread feature score 302. Furthermore, as an example, the use of the spread feature score 302 should be avoided until all of the feature weight 312 within the model vector 324 has been modified once. The spread module 336 can control the extent of the spread by adjusting the spread parameter 340.

More specifically, the spread module 336 can calculate the spread feature score 302 for each representations of the class 308 for the feature 306. The spread module 336 can send the spread feature score 302 to an update module 335.

It has been discovered that the computing system 100 can calculate the spread feature score 302 to overcome the weakness presented by the training setup of the binary classifiers to improve precision and recall for multi-class classification problems. The binary classifier, such as “One vs. One training,” ignores how the other representations of the class 308 can affect the classification of the two being compared. And the binary classifier, such as “One vs. All training,” ignores the distinction amongst a plurality of the class 308. To overcome the weakness, the computing system 100 can operate on and change a set of scores.

More specifically, the computing system 100 can overcome the weakness by spreading out a set of the plurality of the feature weight 312 by calculating the spread feature score 302 to change a plurality of a spread distance 342 amongst the plurality of the feature weight 312 without changing the relative order of the instances of the feature weight 312. The spread distance 342 is a relative distance between weights, scores, vectors, or a combination thereof. For example, the spread distance 342 can represent the relative distance between one instance of the feature weight 312 and another instance of the feature weight 312.

For another example, the spread distance 342 can represent the relative distance between one instance of the spread feature score 302 and another instance of the spread feature score 302. Moreover, the computing system 100 can spread out the set of the feature weight 312 by factoring a set of the feature weight 312 from the class 308 that is different. Thus, the computing system 100 can improve the precision and recall by magnifying, diminishing, or a combination thereof the spread distance 342 between the instances of the feature weight 312 but maintaining the relative order amongst the instances of the feature weight 312.

It has been further discovered that the computing system 100 can calculate the spread feature score 302 to change the spread distance 342 of the plurality of the feature weight 312 for improving the accuracy of classifying the feature 306, the data object 304, or a combination thereof into the class 308. By factoring the spread parameter 340 and the feature weight 312 of other representations of the class 308, the computing system 100 can calculate the spread feature score 302 by diminishing or squishing the spread distance 342 between the instances of the feature weight 312 if the feature weight 312 is closer to zero. In contrast, the computing system 100 can calculate the spread feature score 302 by magnifying or spreading the spread distance 342 between the instances of the feature weight 312 if the feature weight 312 is further away from zero. As a result, the computing system 100 can improve the classification of the feature 306, the data object 304, or a combination thereof to the class 308 based on the spread distance 342 altered.

The computing system 100 can include the update module 335, which can couple to the spread module 336. The update module 335 can be depicted as “Step 4” in FIG. 3. The update module 335 generates an update vector 337. For example, the update module 335 can generate the update vector 337 based on the spread feature score 302.

The update module 335 can generate the update vector 337 in a number of ways. For example, the update module 335 can generate the update vector 337 by updating the model vector 324. More specifically, the update module 335 can generate the update vector 337, which is an updated instance of the model vector 324 having the paired value representing the feature 306 and the spread feature score 302 replacing the feature weight 312 for the class 308.

As an example, the class 308 can represent “sad.” The feature 306 can represent “so disheartening.” The feature weight 312 can represent “positive 0.5.” The spread feature score 302 can represent “positive 0.6.” The model module 311 can generate the update vector 337 having the paired value of “so disheartening” and “positive 0.6” for the class 308 representing “sad.”

For further example, the model module 311 can generate the update vector 337 having other instances of the feature 306 from the same instance of the data object 304 for the class 308. More specifically, the other instance of the feature 306 within the same instance of the data object 304 can represent “silly.” The update module 335 can generate the update vector 337 having the paired value of “silly” and the spread feature score 302 for “silly” for the class 308 representing “sad” along with the paired value of “so disheartening” and “positive 0.6” for the class 308 representing “sad.”

For further example, the update module 335 can generate the update vector 337 for each representations of the class 308 for the same instance of the feature 306. The update module 335 can send the update vector 337 to an orientation module 330.

The computing system 100 can include the orientation module 330, which can couple to the update module 335. The orientation module 330 can be depicted as “Step 5” in FIG. 3. The orientation module 330 determines an item orientation 332. For example, the orientation module 330 can determine the item orientation 332 of the data object 304 based on a plurality of the update vector 337 from each representations of the class 308. Furthermore, the orientation module 330 can determine the bias threshold 318 based on the item orientation 332 for the data object 304.

The item orientation 332 is a score indicating that the data object 304 is oriented towards the class 308 of a particular representation. For example, the item orientation 332 can include the positive orientation 314, the negative orientation 316, or a combination thereof. For a specific example, the data object 304 can indicate the positive orientation 314 towards the class 308 of “sad” while indicating the negative orientation 316 towards the class 308 of “happy.”

The orientation module 330 can determine the item orientation 332 using a dot product of the feature weight 312 and a term frequency 334. For example, the feature weight 312 can be replaced with the spread feature score 302. The term frequency 334 is a number of occurrences of the feature 306 within the data object 304.

For a specific example, the orientation module 330 can determine the positive orientation 314 if the dot product of the data object 304 with the feature weight 312 meets or exceeds the bias threshold 318. In contrast, if the dot product of the data object 304 with the feature weight 312 is below the bias threshold 318, the orientation module 330 can determine the data object 304 to have the negative orientation 316.

More specifically, the bias threshold 318 can be set to zero. If the dot product of the feature weight 312 and the term frequency 334 meets or exceeds the bias threshold 318, the orientation module 330 can determine the item orientation 332 to represent the positive orientation 314. In contrast, if the dot product of the feature weight 312 and the term frequency 334 is below the bias threshold 318, the orientation module 330 can determine the item orientation 332 to represent the negative orientation 316.

For another example, if the dot product of the bias balanced vector 322 and the term frequency 334 meets or exceeds the bias threshold 318, the orientation module 330 can determine the item orientation 332 to represent the positive orientation 314. In contrast, if the dot product of the bias balanced vector 322 and the term frequency 334 is below the bias threshold 318, the orientation module 330 can determine the item orientation 332 to represent the negative orientation 316.

For further example, the bias threshold 318 can be determined or learned by the orientation module 330 to dynamically adjust the value of the bias threshold 318. More specifically, the orientation module 330 can loop over the model vector 324 or the update vector 337 to measure the accuracy of the model vector 324 or the update vector 337. For a specific example, the orientation module 330 can evaluate the F₁ score of the model vector 324 or the update vector 337 with the feature weight 312. The orientation module 330 can adjust the bias threshold 318 based on the F₁ score evaluated.

Furthermore, the orientation module 330 can determine the bias threshold 318 based on the data object 304 having the item orientation 332 determined, the data object 304 with the item orientation 332 undetermined, or a combination thereof. Further, the orientation module 330 can determine the bias threshold 318 based on comparing a frequency of the data object 304 with the positive orientation 314 to a frequency of the data object 304 with the negative orientation 316.

The physical transformation from calculating the spread feature score 302 results in the movement in the physical world, such as people using the first device 102, based on the operation of the computing system 100. As the movement in the physical world occurs, the movement itself creates additional information that is converted back into generating the data object 304 for further extraction of the feature 306 from the data object 304 for the continued operation of the computing system 100 and to continue movement in the physical world.

The first software 226 of FIG. 2 of the first device 102 of FIG. 2 can include the computing system 100. For example, the first software 226 can include the training module 310, the model module 311, the procedure module 320, the spread module 336, the update module 335, and the orientation module 330.

The first control unit 212 of FIG. 2 can execute the first software 226 for the training module 310 to calculate the feature weight 312. The first control unit 212 can execute the first software 226 for the model module 311 to generate the model vector 324. The first control unit 212 can execute the first software 226 for the procedure module 320 to calculate the bias balanced vector 322. The first control unit 212 can execute the first software 226 for the update module 335 to generate the update vector 337. The first control unit 212 can execute the first software 226 for the spread module 336 to calculate the spread feature score 302. The first control unit 212 can execute the first software 226 for the orientation module 330 to determine the item orientation 332.

The second software 242 of FIG. 2 of the second device 106 of FIG. 2 can include the computing system 100. For example, the second software 242 can include the training module 310, the model module 311, the procedure module 320, the spread module 336, the update module 335, and the orientation module 330.

The second control unit 234 of FIG. 2 can execute the second software 242 for the training module 310 to calculate the feature weight 312. The second control unit 234 can execute the second software 242 for the model module 311 to generate the model vector 324. The second control unit 234 can execute the second software 242 for the procedure module 320 to calculate the bias balanced vector 322. The second control unit 234 can execute the second software 242 for the update module 335 to generate the update vector 337. The second control unit 234 can execute the second software 242 for the spread module 336 to calculate the spread feature score 302. The second control unit 234 can execute the second software 242 for the orientation module 330 to determine the item orientation 332.

The computing system 100 can be partitioned between the first software 226 and the second software 242. For example, the second software 242 can include the model module 311, the procedure module 320, the update module 335, the orientation module 330, and the spread module 336. The second control unit 234 can execute modules partitioned on the second software 242 as previously described.

The first software 226 can include the training module 310. Based on the size of the first storage unit 214 of FIG. 2, the first software 226 can include additional modules of the computing system 100. The first control unit 212 can execute the modules partitioned on the first software 226 as previously described.

The first control unit 212 can operate the first communication unit 216 of FIG. 1 to send the model vector 324 to the second device 106. Moreover, the first communication unit 216 can receive the data object 304 of FIG. 3 from external sources. The second communication unit 236 of FIG. 2 can send the spread feature score 302 to the first device 102 through the communication path 104 of FIG. 2. Moreover, the second communication unit 236 can receive the data object 304 from external sources.

The first control unit 212 can operate the first control interface 222 of FIG. 2 to receive the data object 304 from external sources. The second control unit 234 can operate the second control interface 244 of FIG. 2 to receive the data object 304 from external sources.

The computing system 100 describes the module functions or order as an example. The modules can be partitioned differently. For example, the procedure module 320 and the orientation module 330 can be combined. Each of the modules can operate individually and independently of the other modules. Furthermore, data generated in one module can be used by another module without being directly coupled to each other. For example, the spread module 336 can receive the bias balanced vector 322 from the procedure module 320.

The modules described in this application can be hardware circuitry, hardware implementation, or hardware accelerators in the first control unit 212 or in the second control unit 234. The modules can also be hardware circuitry, hardware implementation, or hardware accelerators within the first device 102 or the second device 106, but outside of the first control unit 212 or the second control unit 234, respectively, as depicted in FIG. 3. However, it is understood that the first control unit 212, the second control unit 234, or a combination thereof can collectively refer to all hardware accelerators for the modules.

The modules described in this application can be implemented as instructions stored on a non-transitory computer readable medium to be executed by a first control unit 212, the second control unit 236, or a combination thereof. The non-transitory computer medium can include the first storage unit 214 of FIG. 2, the second storage unit 246 of FIG. 2, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

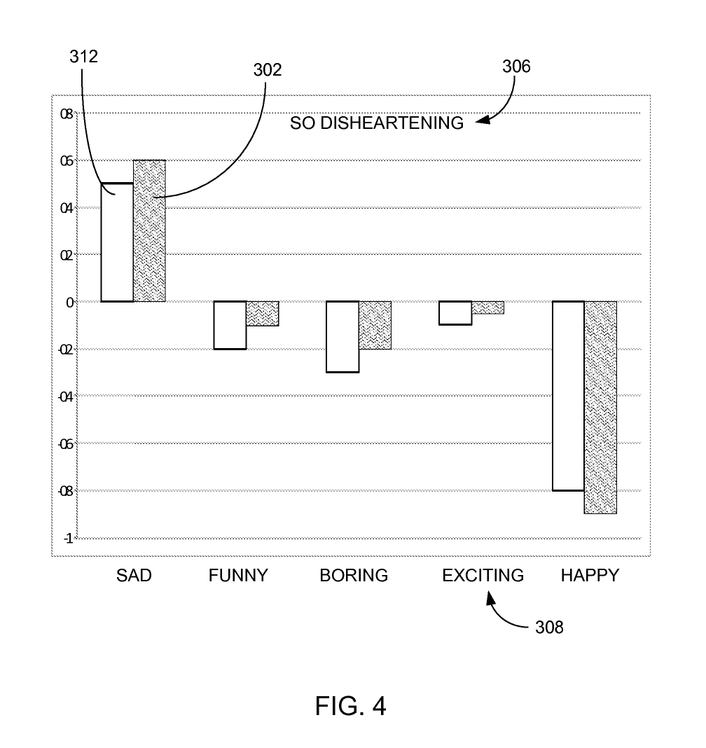

Referring now to FIG. 4, therein is shown an example of a graphical representation of the feature weight 312 and the spread feature score 302. More specifically, the bar graph can represent the feature weight 312 and the spread feature score 302 for each representations of the class 308. As an example, the y-axis can represent the value for the feature weight 312, the spread feature score 302, or a combination thereof. The x-axis can represent the various representations of the class 308.

For a specific example, the feature 306 can represent “so disheartening.” The feature weight 312 can have a value of “0.5” for the class 308 representing “sad.” And the spread feature score 302 can have a value of “0.6” for the class 308 representing “sad.” As illustrated, the computing system 100 can maintain the original sign and relative order of the instances of the feature weight 312.

It has been discovered that the computing system 100 calculating the spread feature score 302 improves the Mean Average Precision (MAP) score by 10 percentage points for the feature 306. Using the spread feature score 302 can improve the search of the data object 304 of FIG. 3 having the particular instance of the feature 306. As a result, the computing system 100 can improve the identification of the data object 304 oriented towards the class 308 of FIG. 3 of a particular representation for enhanced user experience of the computing system 100.

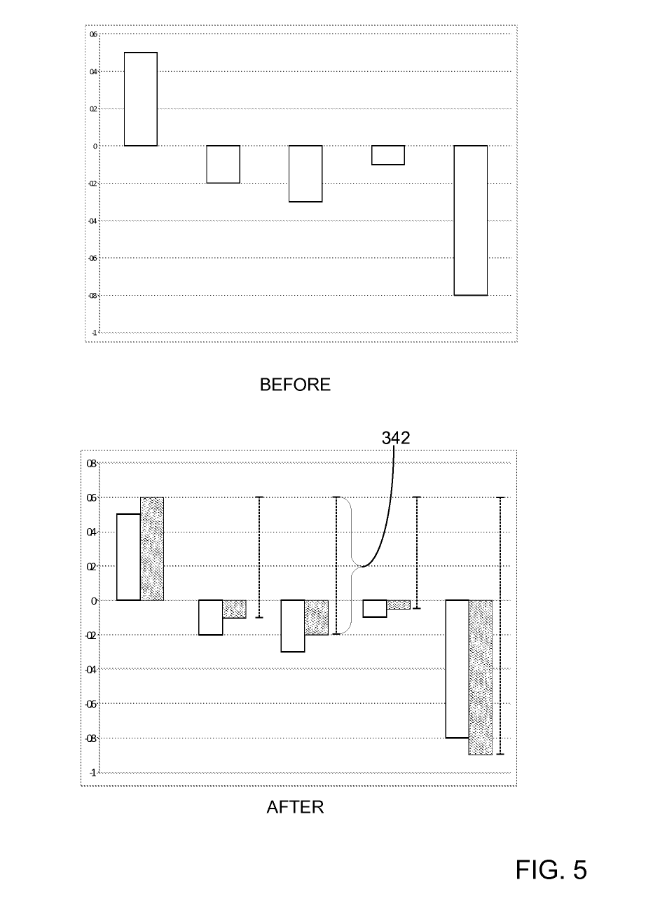

Referring now to FIG. 5, therein is shown an example of a change in the spread distance 342 based on the bar graph illustrated in FIG. 4. FIG. 5 can illustrate the before and after of the spread distance 342 for each representations of the class 308 of FIG. 3 of the feature 306 of FIG. 3 representing “so disheartening.”

As illustrated, the spread distance 342 can represent the relative distance between the class 308 representing “sad” and rest of the emotions, such as “funny,” “boring,” “exciting,” and “happy” in respective order from left to right. More specifically, the spread distance 342 can represent the relative distance between the feature weight 312 for “sad” and the rest of emotions for the bar graph depicted as “before.” And the spread distance 342 can represent the relative distance between the spread feature score 302 and the rest of emotions for the bar graph depicted as “after.”

Furthermore, the spread distance 342 for the “before” diagram can change once the spread feature score 302 is calculated. More specifically, the spread distance 342 between “sad” and “happy” can increase based on the spread feature score 302 for “sad” and the spread feature score 302 for “happy.” The spread distance 342 between the instances of the feature weight 312 can change based on whether the spread distance 342 is expanded or squished according to the spread feature score 302 of each representations of the class 308.

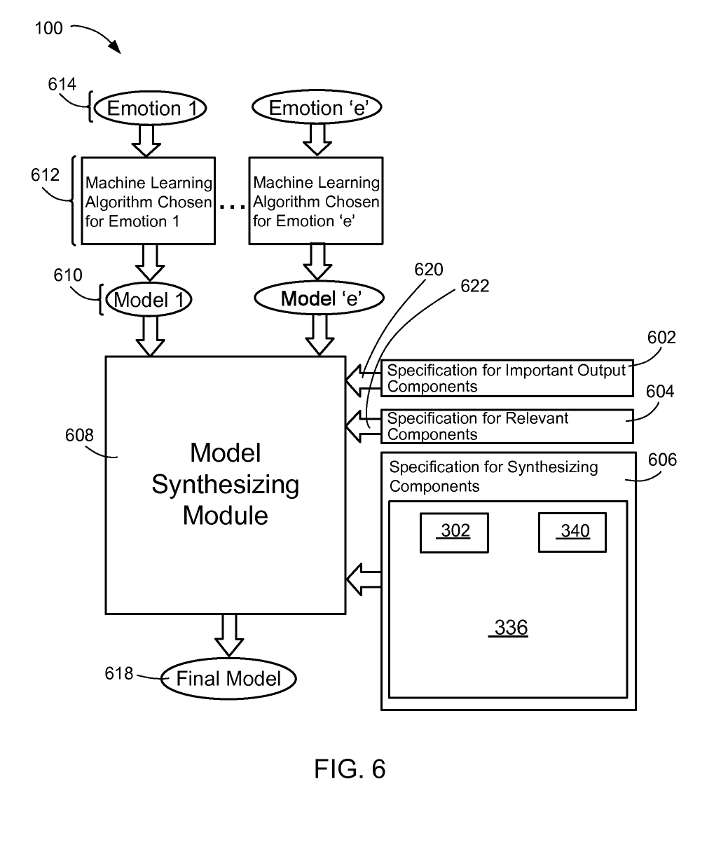

Referring now to FIG. 6, therein is shown an architecture view of an exemplary application for a model synthesis with the computing system 100. The computing system 100 can include an importance specification module 602, a relevance specification module 604, a synthesis specification module 606, and a model synthesis module 608. The computing system 100 can also include emotion-specific models 610 generated by emotion-specific modules 612 based on emotion-specific data 614.

As an example, FIG. 6 provides an architecture on how to build an emotion-independent model 618 to learn a general purpose emotion strength and orientation model of the feature 306 of FIG. 3, such as words and phrases, including those with the item orientation 332 of FIG. 3. FIG. 6 shows how the spread feature score 302 from the synthesis specification module 606 interacts with the model synthesis module 608.

In the example in FIG. 6, the architecture uses a set of the emotion-specific models 610, built on the emotion-specific data 614 for the different emotions, as inputs to the model synthesis module 608 because there is a relationship between the emotions. For this example, Delta IDF is used to build the emotion-specific models 610, but other similar algorithms such as logistic regression could be selected instead.

In this architecture example, the importance specification module 602, a relevance specification module 604, a synthesis specification module 606 also provide inputs to the model synthesis module 608. The importance specification module 602 identifies the important components for the emotion-independent model 618 generated from the model synthesis module 608. The relevance specification module 604 identifies relevant components 622 used by the model synthesis module 608 to build the output components for the emotion-independent model 618. The synthesis specification module 606 specifies how to synthesize the emotion-independent model 618 in the model synthesis module 608 by identifying the output components for the emotion-independent model 618 from the relevant components 622 from the relevance specification module 604.

As a further exemplary description of the synthesis specification module 606, this module for a classification task generates the spread feature score 302. The synthesis specification module 606 can create and return the final model component that was instructed to create. The synthesis specification module 606 can factor the spread parameter 340 to spread the feature weight 312 of FIG. 3 to calculate the spread feature score 302.

For a specific example, the class 308 of FIG. 3 can represent the emotion. The synthesis specification module 606 can set the spread parameter as 2 if the original models are already accurate. The synthesis specification module 606 can set the spread parameter as 3 if the original model is less accurate.

The model synthesis module 608 generates and returns the final model component and the emotion-independent model 618 that it has been instructed based on the important model components 620, the relevant components 622, the spread feature score 302, or a combination thereof.

The modules described in this application can be part of the first software 226 of FIG. 2, the second software 242 of FIG. 2, or a combination thereof. These modules can also be stored in the first storage unit 214 of FIG. 2, the second storage unit 246 of FIG. 2, or a combination thereof. The first control unit 212, the second control unit 234, or a combination thereof can execute these modules for operating the computing system 100.

The computing system 100 has been described with module functions or order as an example. The computing system 100 can partition the modules differently or order the modules differently. For example, the synthesis specification module 606 can include the spread module 336.

The modules described in this application can be hardware implementation, hardware circuitry, or hardware accelerators in the first control unit 212 of FIG. 2 or in the second control unit 234 of FIG. 2. The modules can also be hardware implementation, hardware circuitry, or hardware accelerators within the first device 102 or the second device 106 but outside of the first control unit 212 or the second control unit 234, respectively.

The control flow 300 or a method 300 includes: calculating a feature weight of the feature for each classes with a control unit; generating a model vector for each of the classes based on the feature weight; and calculating a spread feature score based on the model vector, a spread parameter, or a combination thereof for changing a spread distance amongst a plurality of the feature weight.

It has been discovered that feature score can be used to generate interrelated emotion models that outperform emotion-specific models. This allows for improved recommender systems with more accurate orientation or emotion models. This also allows for more opinion expressions and more diverse opinion expressions when doing emotion and opinion mining. This further improves electronic personal assistants with more accurate emotion information. This yet further increases the accuracy of data analytics and business intelligence that uses emotion analysis technology.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
a first communication unit configured to receive a feature within a data object; and
a control unit, coupled to the first communication unit, configured to:
calculate a feature weight of the feature for each classes,
generate a model vector for each of the classes based on the feature weight, and
calculate a spread feature score based on the model vector, a spread parameter, or a combination thereof for changing a spread distance amongst a plurality of the feature weight.

2. The system as claimed in claim 1 wherein the control unit is configured to calculate the spread feature score based on magnifying the spread distance amongst a plurality of the feature weight.

3. The system as claimed in claim 1 wherein the control unit is configured to calculate the spread feature score based on diminishing the spread distance amongst a plurality of the feature weight.

4. The system as claimed in claim 1 wherein the control unit is configured to calculate the spread feature score based on adjusting the spread parameter for controlling the spread distance being altered.

5. The system as claimed in claim 1 wherein the control unit is configured to generate an update model vector based on the spread feature score.

6. The system as claimed in claim 1 wherein the control unit is configured to determine an item orientation of the data object based on dot product of the feature weight and a term frequency.

7. The system as claimed in claim 1 wherein the control unit is configured to determine a positive orientation of the data object based on dot product of the feature weight and a term frequency meeting or exceeding a bias threshold.

8. The system as claimed in claim 1 wherein the control unit is configured to determine a negative orientation of the data object based on dot product of the feature weight and a term frequency below a bias threshold.

9. The system as claimed in claim 1 wherein the control unit is configured to calculate the feature weight for determining an item orientation of the data object.

10. The system as claimed in claim 1 wherein the control unit is configured to calculate the bias balanced vector based on normalizing a positive vector, a negative vector, or a combination thereof.

11. A method of operation of a computing system comprising:
calculating a feature weight of the feature for each classes with a control unit;
generating a model vector for each of the classes based on the feature weight; and
calculating a spread feature score based on the model vector, a spread parameter, or a combination thereof for changing a spread distance amongst a plurality of the feature weight.

12. The method as claimed in claim 11 wherein calculating the spread feature score includes calculating the spread feature score based on magnifying the spread distance amongst a plurality of the feature weight.

13. The method as claimed in claim 11 wherein calculating the spread feature score includes calculating the spread feature score based on diminishing the spread distance amongst a plurality of the feature weight.

14. The method as claimed in claim 11 wherein calculating the spread feature score includes calculating the spread feature score based on adjusting the spread parameter for controlling the spread distance being altered.

15. The method as claimed in claim 11 further comprising generating an update model vector based on the spread feature score.

16. A non-transitory computer readable medium comprising:
calculating a feature weight of the feature for each classes;
generating a model vector for each of the classes based on the feature weight; and
calculating a spread feature score based on the model vector, a spread parameter, or a combination thereof for changing a spread distance amongst a plurality of the feature weight.

17. The non-transitory computer readable medium as claimed in claim 16 wherein calculating the spread feature score includes calculating the spread feature score based on magnifying the spread distance amongst a plurality of the feature weight.

18. The non-transitory computer readable medium as claimed in claim 16 wherein calculating the spread feature score includes calculating the spread feature score based on diminishing the spread distance amongst a plurality of the feature weight.

19. The non-transitory computer readable medium as claimed in claim 16 wherein calculating the spread feature score includes calculating the spread feature score based on adjusting the spread parameter for controlling the spread distance being altered.

20. The non-transitory computer readable medium as claimed in claim 16 further comprising generating an update model vector based on the spread feature score.
